(19) United States
(12) Patent Application Publication
(10) Pub. No.: US 2011/0001728 A1
(43) Pub. Date: Jan. 6, 2011

(54) POINTING DEVICE AND DISPLAY DEVICE USING THE SAME

(75) Inventor: Hideo Hosorogi, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, OSAKA-SHI OSAKA (JP)

(21) Appl. No.: 12/593,213

(22) PCT Filed: Mar. 26, 2008
(86) PCT No.: PCT/JP2008/055660

§ 371 Date: Sep. 25, 2009

(30) Foreign Application Priority Data
Mar. 26, 2007 (JP) 2007-079740

(51) Int. Cl. G09G 3/36; G06F 3/042

(52) U.S. Cl. 345/175; 345/102

(57) ABSTRACT

A pointing device has a photosensor (17) provided on the liquid crystal panel (display unit) (11) side of a liquid crystal display device (1), and is provided with a light quantity change instruction unit (brightness increase instruction unit) (43) that instructs the liquid crystal display device (1) to increase the quantity of irradiated light from a backlight device (12) that is irradiated from the liquid crystal panel (11) toward the outside.

### TECHNICAL FIELD

The present invention relates to a pointing device for receiving an input of an instruction or the like from a user, and a display device using the same.

### BACKGROUND ART

In general, a pointing device is constituted separately from a display device, and has a detection module that is mounted on a display unit of the display device, as in the example of existing touch panels that are resistive type, capacitance type, or the like. However, in recent years, in addition to the need to have a small size and be thin, which are demands for pointing devices particularly in mobile applications, there has been demand for a reduction in cost and the number of parts for pointing devices.

In view of this, there are conventional pointing devices that utilize photosensors incorporated a liquid crystal panel used as the display unit, proposals for which are disclosed in, for example, JP 2006-3857A and JP 2006-79589A. Also, based on differences in the light that is used in the detection operation performed by the photosensors (the light that incidences on the photosensors), such conventional pointing devices can be broadly classified into first conventional examples that utilize external light and second conventional examples that utilize irradiated light from the display device.

Specifically, in the first conventional example of a pointing device, a plurality of photosensors are disposed in the liquid crystal panel, and when a detection target of the photosensors, such as a finger, exists above the surface of the liquid crystal panel, different amounts of external light are detected by the photosensors depending on where they are disposed. In other words, external light is obstructed by the detection target, and the amount of light detected by a photosensor directly under the detection target is significantly lower than other photosensors, thus enabling obtaining information on the position coordinates of the detection target.

Also, in the second conventional example of a pointing device, irradiated light from the display device is reflected off the detection target and detected by a plurality of photosensors disposed in the liquid crystal panel. With such a pointing device, information on the position coordinates of the detection object is obtained based on differences in the amount of reflected light that is detected.

### DISCLOSURE OF INVENTION

### Problem to be Solved by the Invention

However, with conventional pointing devices such as are described above, depending on the surrounding environment, the brightness of an operation input screen displayed on the display unit, and the like, there have been cases in which the detection accuracy of the photosensors decreases, and cases in which position coordinate information cannot be appropriately acquired.

Specifically, in FIG. 14, a liquid crystal display device 100 includes a liquid crystal panel 111 in which a liquid crystal layer 114 is sandwiched between a pair of transparent substrates 113 and 115, and a backlight device 112. Also, in the liquid crystal display device 100, a plurality of photosensors 117 included in the first conventional example of the pointing device are disposed one each in a plurality of pixels provided in the liquid crystal layer 114. Normally, external light L0 is irradiated substantially uniformly on all of the photosensors 117 in the liquid crystal display device 100.

Here, in the exemplary case in which a finger F exists in the proximity of the surface of the liquid crystal panel 111, different amounts external light L0 incident on the photosensor 117 disposed under the finger F and the photosensors 117 that are away from the finger F. Accordingly, with the first conventional example of the pointing device, information on the position coordinates of the finger F can be acquired from information on the incidence amount distribution, with respect to the external light L0, from the photosensors 117. In other words, in this case, it is possible to detect that the finger F exists in an area in which the incidence amount from the photosensors 117 is low (the detected intensity of the photosensors 117 is weak).

However, with the first conventional example of the pointing device, if the surrounding environment is dark, that is to say, if the intensity of the external light L0 is weak, the level difference in the incidence amount distribution from the photosensors 117 is small, and therefore specifying the position of the finger F and acquiring information on the position coordinates thereof is difficult.

Also, in FIG. 15, a liquid crystal display device 200 includes a liquid crystal panel 211 in which a liquid crystal layer 214 is sandwiched between a pair of transparent substrates 213 and 215, and a backlight device 212. Also, in the liquid crystal display device 200, photosensors 217 included in the second conventional example of the pointing device are disposed in pixels provided in the liquid crystal layer 214. Normally, in the liquid crystal display device 200, irradiated light L11 from the backlight device 212 is irradiated to the outside through the liquid crystal panel 211.

Here, in the exemplary case in which the finger F exists in the proximity of the surface of the liquid crystal panel 211, part of reflected light L12 from the finger F incidences on the liquid crystal panel 211 and is detected by the photosensor 217 disposed under the finger F. Accordingly, in the second conventional example of the pointing device, the amount of reflected light L12 that is detected is different from a photosensor 217 that is away from the finger F (not shown), and therefore information on the position coordinates of the finger F can be acquired from information on the detection amount distribution, with respect to the reflected light L12, from the photosensors 217. In other words, in this case, it is possible to detect that the finger F exists in an area in which the reflected light L12 detection amount from the photosensors 217 is high (the detection intensity of the photosensors 217 is intense).

However, with the second conventional example of the pointing device, if a display image such as an operation input screen displayed by the liquid crystal display device 200 is a dark image, that is to say, if the intensity of the light from the liquid crystal display device 200 that is irradiated to the outside is weak, the intensity of the reflected light L12 from the finger F is also low. For this reason, the level difference in the detection amount distribution from the photosensors 217 is small, and specifying the position of the finger F and acquiring information on the position coordinates thereof is difficult.

As described above, with conventional pointing devices, there have been cases in which it is impossible to prevent a reduction in the detection accuracy of the photosensors due to the influence of the surrounding environment and the like, and cases in which the functionality has decreased.

In view of the issues described above, an object of the present invention is to provide a pointing device in which a reduction in the detection accuracy of photosensors and a reduction in functionality are prevented, and a display device using the same.

### Means for Solving Problem

In order to achieve the object described above, a pointing device according to an aspect of the present invention is a pointing device used in a display device that includes a display unit equipped with a plurality of pixels and that is configured such that an operation input screen can be displayed on the display unit, the pointing device including:

a photosensor provided for each pixel; and

a brightness increase instruction unit that instructs the display device to increase the brightness of light irradiated from the display unit toward the outside.

In the pointing device having the above configuration, the brightness increase instruction unit instructs the display device to increase the brightness of light irradiated from the display unit of the display device toward the outside, thereby enabling improving the intensity of reflected light that is reflected off the detection target of the photosensors. Accordingly, unlike the conventional examples, it is possible to prevent a reduction in the detection accuracy of the photosensors and a reduction in functionality.

Also, in the pointing device described above, it is preferable that in the pointing device, the brightness increase instruction unit instructs the display device to, at a predetermined cycle, increase the brightness of the light irradiated from the display unit toward the outside.

In this case, it is possible to prevent the increase in the brightness of the light from being seen as flickering, and a reduction in the display quality of the display device can be reliably prevented.

Also, in the pointing device described above, a light quantity change instruction unit that changes the quantity of irradiated light from a backlight device provided on the display device side may be used in the brightness increase instruction unit.

In this case, the intensity of the reflected light is be improved in accordance with the increase in the quantity of the irradiated light, and it is possible to reliably prevent a reduction in the detection accuracy of the photosensors and a reduction in functionality arising therefrom.

Also, in the pointing device described above, a gradation change instruction unit that changes a display gradation on the display unit may be used in the brightness increase instruction unit.

In this case, the intensity of the reflected light is improved in accordance with the change of the display gradation to a high-brightness gradation, and it is possible to reliably prevent a reduction in the detection accuracy of the photosensors and a reduction in functionality arising therefrom.

Also, it is preferable that the pointing device described above includes an illuminance sensor that is provided in the proximity of the display unit and detects a surrounding illuminance of the display unit, and

the brightness increase instruction unit instructs the display device to increase the brightness of the light irradiated from the display unit toward the outside, with use of a determination result of the illuminance sensor.

In this case, the brightness increase instruction unit can increase the brightness of the light in accordance with the surrounding illuminance of the display unit, thereby enabling reliably preventing a reduction in the detection accuracy of the photosensors due to the surrounding illuminance.

Also, in the pointing device described above, the brightness increase instruction unit may instruct the display device to increase the brightness of the light irradiated from the display unit toward the outside, in accordance with an operation input screen displayed on the display unit.

In this case, the brightness increase instruction unit can increase the brightness of the light in accordance with the operation input screen being displayed on the display unit, thereby enabling reliably preventing a reduction in the detection accuracy of the photosensors due to the brightness of the operation input screen.

Also, in the pointing device described above, it is preferable that the brightness increase instruction unit instructs the display device to, for each pixel, increase the brightness of the light irradiated from the display unit toward the outside.

In this case, the brightness increase instruction unit can increase only the brightness of the light irradiated from a site for receiving an input of an instruction or the like from a user toward the outside, thereby enabling more appropriately causing the display device to increase the brightness of the light, without instructing unnecessary increases in brightness.

Also, the pointing device described above may include a position information acquisition unit that, with use of a detection result of each photosensor, acquires position information with respect to the operation input screen displayed on the display unit.

In this case, the position information acquisition unit uses detection results from the photosensors for which a reduction in detection accuracy has been prevented, thus enabling the position information acquisition unit to easily acquire accurate position information.

Also, the pointing device described above may include a scanner unit that reads image information with use of the detection result of each photosensor.

In this case, the scanner unit uses detection results from the photosensors for which a reduction in detection accuracy has been prevented, thus enabling the scanner unit to easily read accurate image information.

Also, a display device according to another aspect of the present invention uses any of the above pointing devices.

The display device having the above configuration uses the pointing device in which a reduction in the detection accuracy of the photosensors and a reduction in functionality arising therefrom axe prevented, thereby enabling easily constructing a display device that has high-performance pointing device functionality.

Also, in the display device described above, it is preferable that a liquid crystal panel is used in the display unit, and

each photosensor is provided integrally with an active matrix substrate of the liquid crystal panel.

In this case, a small size and thinness can be achieved, and furthermore it is possible to construct a display device that has a small number of parts and incorporates a pointing device that is inexpensive and has high performance.

### EFFECTS OF THE INVENTION

The present invention enables providing a pointing device in which a reduction in the detection accuracy of photosensors and a reduction in functionality are prevented, and a display device using the same.

### BRIEF DESCRIPTION OF DRAWINGS

FIG. 1 is a diagram illustrating a schematic configuration of a pointing device and a liquid crystal display device according to Embodiment 1 of the present invention.

FIG. 2 is a diagram illustrating a configuration of relevant portions of the liquid crystal display device.

FIG. 3 is an equivalent circuit diagram showing a configuration of a photosensor and pixels provided in the liquid crystal display device.

FIG. 4 is a block diagram showing a specific exemplary configuration of a sensor control unit shown in FIG. 1.

FIG. 5 is a block diagram showing a specific exemplary configuration of a signal processing unit shown in FIG. 1.

FIG. 6 is a flowchart showing basic detection operations performed by the pointing device.

FIG. 7 is a diagram illustrating display operations performed by the liquid crystal display device.

FIG. 8 is a diagram illustrating basic detection operations performed by the pointing device.

FIG. 9 is a flowchart showing basic detection operations performed by the pointing device in the case in which the surrounding environment has changed.

FIG. 10 is a diagram illustrating a schematic configuration of a pointing device and a liquid crystal display device according to Embodiment 2 of the present invention.

FIG. 11 is a flowchart showing detection operations performed by the pointing device shown in FIG. 10 in accordance with an operation input screen.

FIG. 12 is a diagram illustrating a specific example of an operation input screen displayed on a display face of the liquid crystal display device.

FIG. 13 is a diagram illustrating detection operations performed by the pointing device shown in FIG. 10.

FIG. 14 is a diagram illustrating basic detection operations performed by a first conventional example of a pointing device.

FIG. 15 is a diagram illustrating basic detection operations performed by a second conventional example of a pointing device.

### DESCRIPTION OF THE INVENTION

Below is a description of preferred embodiments of a pointing device and a display device using the same according to the present invention with reference to the drawings. Note that the following description takes the example of the case in which the present invention is applied to a transmissive liquid crystal display device.

### Embodiment 1

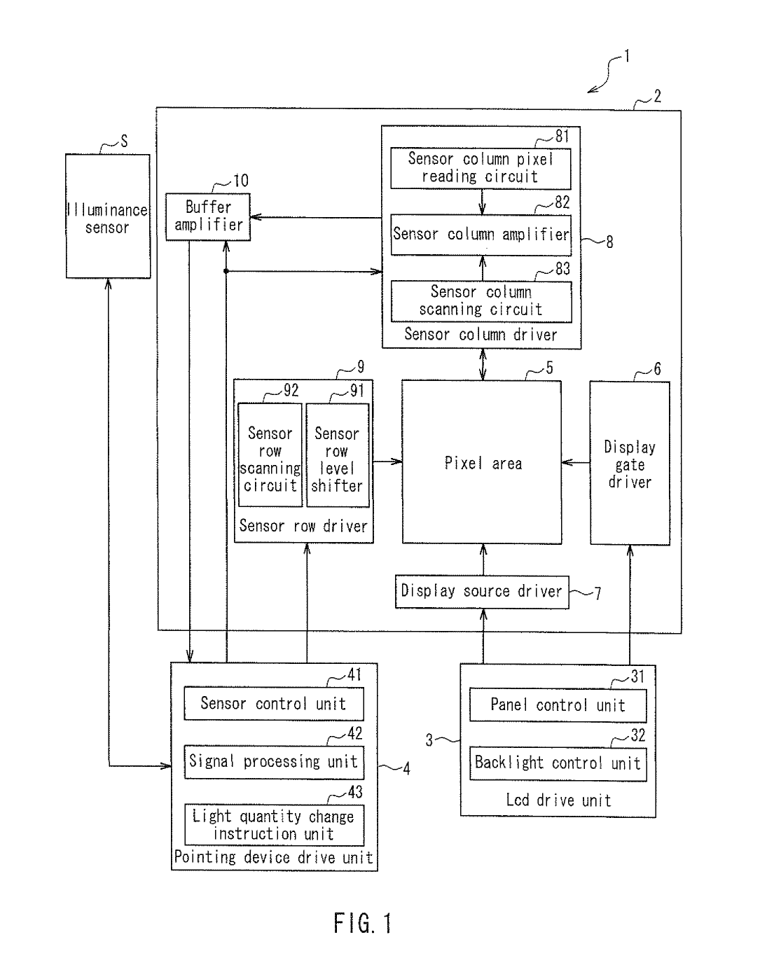

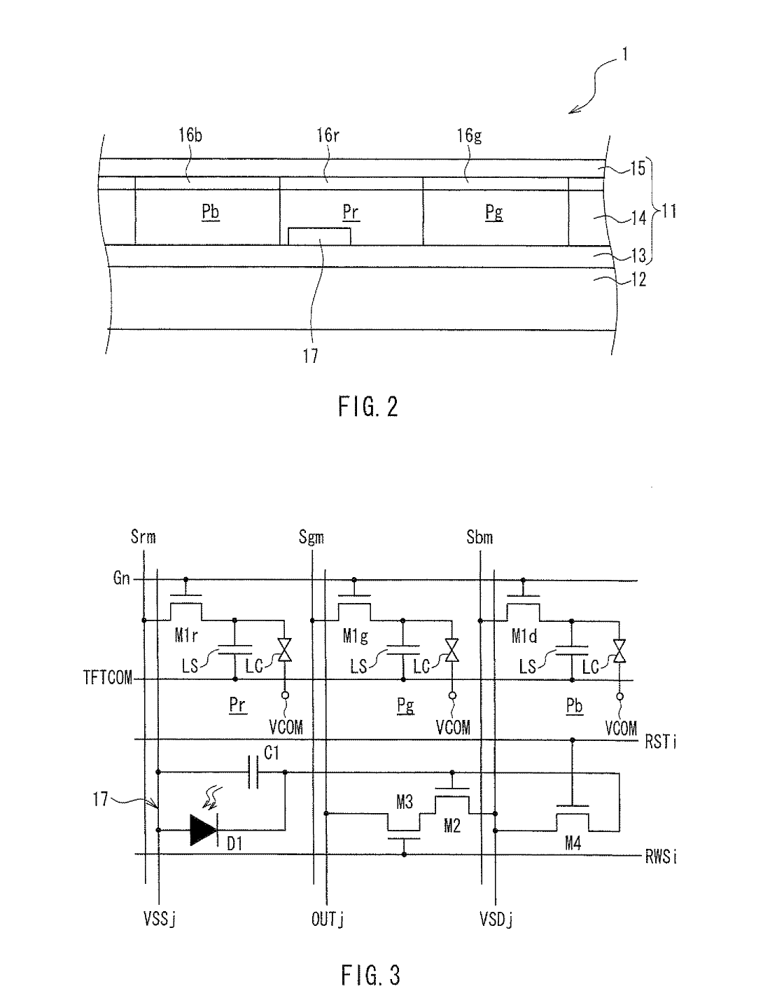

FIG. 1 is a diagram illustrating a schematic configuration of a pointing device and a liquid crystal display device according to Embodiment 1 of the present invention, and FIG. 2 is a diagram illustrating a configuration of relevant portions of the liquid crystal display device. In FIG. 1, a liquid crystal display device 1 of the present embodiment has the pointing device of the present invention integrally incorporated therein, and is equipped with an active matrix substrate 2, and an LCD drive unit 3 and a pointing device drive unit 4 that are constituted separately from the active matrix substrate 2. Also, the liquid crystal display device 1 is provided with an illuminance sensor S included in the pointing device, and the pointing device performs operations for detecting an instruction and the like from a user, in a state in which the influence of changes in the surrounding illuminance has been removed by using a detection result from the illuminance sensor S (described in detail later).

With reference to FIG. 2 as well, the liquid crystal display device 1 is provided with a liquid crystal panel 11 as a display unit, and a backlight device 12 that is disposed on the non-display face side of the liquid crystal panel 11 and irradiates planar illumination light onto the liquid crystal panel 11. The liquid crystal panel 11 includes a pair of transparent substrates 13 and 15, and a liquid crystal layer 14 sandwiched between the transparent substrates 13 and 15.

Red (R), green (G), and blue (B) color filters 16r, 16g, and 16b have been formed on the surface of the transparent substrate 15 that is on the liquid crystal layer 14 side, and the transparent substrate 15 constitutes a CF substrate. Also, the liquid crystal panel 11 is provided with R, G, and B pixels Pr, Pg, and Pb in accordance with the corresponding color filters 16r, 16g, and 16b. Also, the surface of the transparent substrate 15 that is on the opposite side from the liquid crystal layer 14 functions as a display face that displays information such as characters and images.

Switching elements that are described later have been formed for each pixel on the surface of the transparent substrate 13 that is on the liquid crystal layer 14 side, and the transparent substrate 13 constitutes the active matrix substrate 2. Also, a photosensor 17 included in the pointing device is provided integrally with the transparent substrate 13 along with the switching elements. In other words, in the present embodiment, the photosensor 17 is provided integrally with the active matrix substrate 2 of the liquid crystal panel 11. Also, among the pixels Pr, Pg, and Pb, a light receiving element of the photosensor 17 is provided in, for example, the pixel Pr as shown in FIG. 2, and the light receiving element receives light that incidences from outside of the display face (described in detail later).

Also, a known light source (not shown) such as a cold cathode tube or light emitting diode is used in the backlight device 12, and the backlight device 12 emits the illumination light. Also, as described in detail later, the backlight device 12 changes the brightness of the illumination light in accordance with an instruction signal from the pointing device, and is constituted so as to prevent a reduction in the detection accuracy of the photosensor 17 as much as possible.

Also, as shown in FIG. 1, a pixel area 5, a display gate driver 6, a display source driver 7, a sensor column driver 8, a sensor row driver 9, and a buffer amplifier 10 are provided on the active matrix substrate 2. The display gate driver 6 and the display source driver 7 are connected to the LCD drive unit 3 via an FPC (Flexible Printed Circuit) that is not shown, and the sensor column driver 8, the sensor row driver 9, and the buffer amplifier 10 are connected to the pointing device drive unit 4 via another FPC (not shown).

Note that the above-described constituent members on the active matrix substrate 2 can also be formed monolithically on the transparent substrate 13 by a semiconductor process. Alternatively, the drivers among the above-described constituent members may be implemented on the transparent substrate 13 by, for example, COG (Chip On Glass) technology.

Also, as an alternative to the above description, the display gate driver 6 and the display source driver 7 may be connected to the LCD driver 3 via the same FPC that connects the sensor column driver 8, the sensor row driver 9, and the buffer amplifier 10 to the pointing device drive unit 4.

The pixel area 5 constitutes the display face, and is provided with a plurality of the pixels Pr, Pg, and Pb in a matrix configuration. Also, a photosensor 17 is provided in each pixel in the pixel area 5.

The following describes a specific configuration of the pixels Pr, Pg, and Pb, and the photosensors 17, with reference to FIG. 3 as well.

FIG. 3 is an equivalent circuit diagram showing a configuration of a photosensor and pixels provided in the liquid crystal display device.

As shown in FIG. 3, the pixel area 5 is provided with, as wiring for pixels, a gate line Gn and source lines Srm, Sgm, and Sbm that are disposed in a matrix configuration. The gate line Gn is connected to the display gate driver 6. The source lines Srm, Sgm, and Sbm are provided for respective R, G, and B, and are connected to the display source driver 7.

TFTs (Thin Film Transistor) M1r, M1g, and M1b, which are the above-described switching elements for pixels, are provided at intersections between the gate line Gn and the source lines Sun, Sgm, and Shin respectively. In the pixel Pr, a gate electrode, a source electrode, and a drain electrode of the TFT M1r are respectively connected to the gate line Gn, the source line Srm, and a pixel electrode that is not shown. Accordingly, as shown in FIG. 3, a liquid crystal capacitance LC is formed between the drain electrode of the TFT M1r and an opposing electrode (VCOM) in the pixel Pr. Also, a supplementary capacitance LS is formed in parallel with the liquid crystal capacitance LC.

Similarly, in the pixel Pg, a gate electrode, a source electrode, and a drain electrode of the TFT M1g are respectively connected to the gate line Gn, the source line Sgm, and a pixel electrode that is not shown. Accordingly, as shown in FIG. 3, a liquid crystal capacitance LC is formed between the drain electrode of the TFT M1g and an opposing electrode (VCOM) in the pixel Pg. Also, a supplementary capacitance LS is formed in parallel with the liquid crystal capacitance LC.

Also, in the pixel Pb, a gate electrode, a source electrode, and a drain electrode of the TFT M1b are respectively connected to the gate line Gn, the source line Sbm, and a pixel electrode that is not shown. Accordingly, as shown in FIG. 3, a liquid crystal capacitance LC is formed between the drain electrode of the TFT M1b and an opposing electrode (VCOM) in the pixel Pb. Also, a supplementary capacitance LS is formed in parallel with the liquid crystal capacitance LC.

Also, in the pixels Pr, Pg, and Pb, voltage signals (gradation voltages) that correspond to the brightness (gradation) of information to be displayed on the display face are supplied from the display source driver 7 via the corresponding source lines Srm, Sgm, and Sbm.

Specifically, as shown in FIG. 1, the LCD drive unit 3 is provided with a panel control unit 31 and a backlight control unit 32. The panel control unit 31 receives an input of an image signal indicating information to be displayed on the display face from outside of the liquid crystal display device 1. The panel control unit 31 also generates and outputs instruction signals to the display gate driver 6 and the display source driver 7 in accordance with the input image signal.

Accordingly, based on an instruction signal from the panel control unit 31, the display gate driver 6 sequentially outputs, to the gate lines Gn arranged in a matrix configuration, a gate signal for causing the gate electrodes of the corresponding TFTs M1r, M1g, and M1b to be in the ON state. On the other hand, based on an instruction signal from the panel control unit 31, the display source driver 7 supplies the gradation voltages to the pixels Pr, Pg, and Pb via the corresponding source lines Srm, Sgm, and Sbm.

Also, the backlight control unit 32 receives, from a controller or the like provided in the liquid crystal display device 1, an input of a dimming instruction signal that instructs a change in the brightness of the illumination light. Also, the backlight control unit 32 is configured to control the supply of power to the light source of the backlight device 12 based on the input dimming instruction signal. The backlight control unit 32 is also configured to increase or decrease the supply of power to the light source in accordance with an instruction signal from a later-described light quantity change instruction unit 43 that is provided in the pointing device drive unit 4, and can adjust irradiated light from the backlight device 12.

Also, as shown in FIG. 3, the photosensor l 7 includes a photodiode D1 as the light reception element described above, a capacitor C1, and TFTs M2 to M4. Also, the photosensor 17 is supplied with a constant voltage from the sensor column driver 8 via wiring VSSj and VSDj that are provided parallel to the source lines Srm and Sbm respectively. Also, the photosensor 17 is configured to output a detection result to a sensor column pixel reading circuit 81 of the sensor column driver 8 via a wiring OUTj that is provided parallel to the source line Sm.

Also, the TFT M4 is connected to a wiring RSTi for supplying a reset signal. The TFT M3 is connected to a wiring RWSi for supplying a read signal. The wiring RSTi and RWSi are connected to the sensor row driver 9.

As shown in FIG. 1, the sensor column driver 8 includes the sensor column pixel reading circuit 81, a sensor column amplifier 82, and a sensor column scanning circuit 83, and the sensor column driver 8 operates in accordance with an instruction signal from a sensor control unit 41 of the pointing device drive unit 4. The sensor column pixel reading circuit 81 successively receives, via the wiring OUTj, an input of detection results (voltage signals) from the photosensors 17 provided in a matrix configuration in the pixel area 5. The sensor column pixel reading circuit 81 also outputs the input voltage signals to the sensor column amplifier 82.

The sensor column amplifier 82 includes amplifiers (not shown) that are provided corresponding to the photosensors 17, and the sensor column amplifier 82 amplifies the corresponding voltage signals and outputs the resulting signals to the buffer amplifier 10. In accordance with an instruction signal from the sensor control unit 41, the sensor column scanning circuit 83 outputs, to the sensor column amplifier 82, a column select signal for causing the amplifiers of the sensor column amplifier 82 to be sequentially connected to the buffer amplifier 10. Accordingly, the post-amplification voltage signals are output from the sensor column amplifier 82 to the pointing device drive unit side through the buffer amplifier 10.

The sensor row driver 9 is provided with a sensor row level shifter 91 that uses a shifter register, and a sensor row scanning circuit 92. In accordance with an instruction signal from the sensor control unit 41, the sensor row scanning circuit 92 sequentially selects the wiring RSTi and RWSi at a predetermined time interval. Accordingly, in the pixel area 5, photosensors 17 whose voltage signals (detection results) are to be read are sequentially selected line-by-line in the matrix configuration.

Note that although one photosensor 17 is provided in one group of R, G, and B pixels Pr, Pg, and Pb in the pixel area 5 in the above description, the disposed number of photosensors 17 in the pixel area 5 and the disposition locations and the like of the photodiodes D1 and the like included therein are not limited to the above description, but instead are arbitrary. For example, a configuration is possible in which a photodiode D1 that performs substantial light detection is provided in each of the pixels Pr, Pg, and Pb, and a photosensor 17 is provided in each pixel.

The pointing device drive unit 4 is provided with the sensor control unit 41, a signal processing unit 42, and the light quantity change instruction unit 43. Also, the pointing device drive unit 4 receives an input of an operation instruction from a user via, for example, a controller provided on the liquid crystal display device 1 side, and the sensor control unit 41, the signal processing unit 42, and the light quantity change instruction unit 43 in the pointing device drive unit 4 operate appropriately in accordance with the input operation instruction.

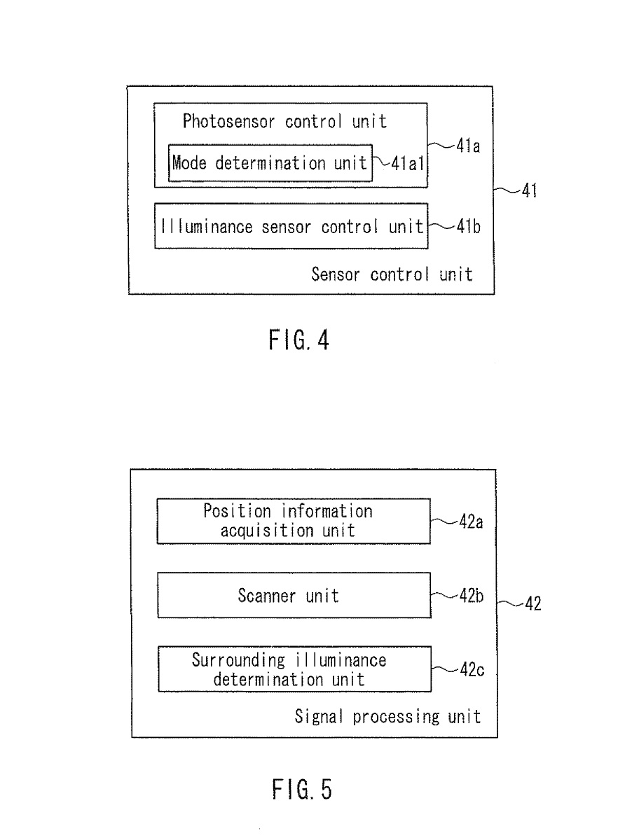

As shown in FIG. 4, the sensor control unit 41 is provided with a photosensor control unit 41a that controls driving of the photosensors 17, and an illuminance sensor control unit 41b that controls driving of the illuminance sensor S. The photosensor control unit 41a is provided with a mode determination unit 41a1 that determines either a sensing mode in which the photosensors 17 are caused to perform detection operations, or a standby mode in which the sensing operations of the photosensors 17 are stopped and the photosensors 17 are caused to be on standby. In other words, the photosensor control unit 41a can switch the photosensors 17 to either a sensing operation state or a stopped state in according with the operation instruction. When the mode determination unit 41a1 has determined that the current mode is the sensing mode, the photosensor control unit 41a outputs the instruction signals to the sensor column driver 8 and the sensor row driver 9, and causes the photosensors 17 to perform sensing operations. Also, detection results from the photosensors 17 are stored in a memory (not shown) provided in the pointing device drive unit 4.

While the sensing mode is being executed, the illuminance sensor control unit 41b causes the illuminance sensor S provided in the proximity of the liquid crystal panel 11 to operate. Accordingly, the surrounding illuminance of the liquid crystal panel 11 is detected, and the detection result from the illuminance sensor S is stored in the memory described above.

Also, as shown in FIG. 5, the signal processing unit 42 is provided with a position information acquisition unit 42a, a scanner unit 42b, and a surrounding illuminance determination unit 42c. The position information acquisition unit 42a acquires position information regarding, for example, a user's finger over the display face of the liquid crystal panel 11, with use of the detection results from the photosensors 17 that are stored in the memory. In other words, the position information acquisition unit 42a can acquire information regarding a position on, for example, an operation input screen (instruction input screen) that is displayed on the liquid crystal panel 11.

Also, the scanner unit 42b is configured to read image information with use of the detection results from the photosensors 17 that are stored in the memory, and the scanner unit 42b stores the read image information data in the memory. Furthermore, the scanner unit 42b is configured so as to be able to read not only characters, photographs, and the like, but also a user's fingerprint as an image, and the scanner unit 42b can construct a fingerprint authentication system using the liquid crystal display device 1.

The surrounding illuminance determination unit 42c determines a surrounding illuminance of the liquid crystal panel 11 with use of the detection result from the illuminance sensor S that is stored in the memory. The surrounding illuminance determination unit 42c also outputs the determined result to the light quantity change instruction unit 43.

The light quantity change instruction unit 43 constitutes a brightness increase instruction unit that instructs the liquid crystal display device 1 to increase the brightness of the light that is irradiated, from the liquid crystal panel 11 toward the outside. Specifically, the light quantity change instruction unit 43 instructs the backlight control unit 32 on the liquid crystal display device 1 side to increase the brightness of the irradiation light by increasing the quantity of light that is irradiated from the backlight device 12. Accordingly, as described in detail later, a reduction in the detection accuracy of the photosensors 17 can be prevented in the pointing device.

Also, based on the determination result from the surrounding illuminance determination unit 42c, the light quantity change instruction unit 43 instructs the backlight control unit 32 to increase the brightness of the irradiation light (described in detail later).

Furthermore, at a predetermined cycle, the light quantity change instruction unit 43 causes the brightness of the entire light emitting face of the backlight device 12 to be increased. Specifically, in the case of continuously causing the brightness of the entire light emitting face to be increased, the light quantity change instruction unit 43 outputs, to the backlight control unit 32, the instruction signal for causing the brightness to be increased at a cycle of 0.017 seconds or less (a cycle of 60 Hz or more) as the predetermined cycle. Accordingly, it is possible to prevent the increase in brightness by the backlight device 12 from being seen as flickering.

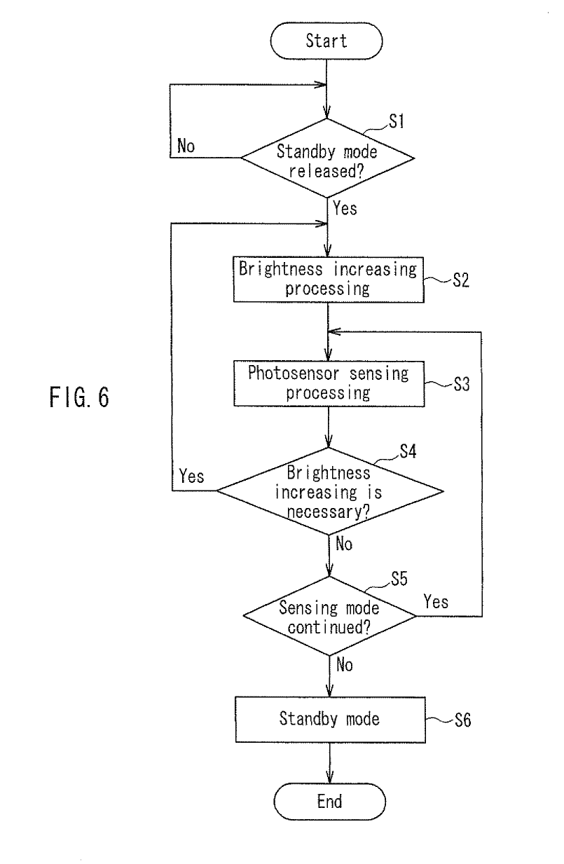

The following is a specific description of operations in the present embodiment having the above configuration, with reference to FIGS. 6 to 9 as well.

First is a description of display operations performed by the liquid crystal display device 1 and basic detection operations performed by the pointing device, with reference to FIGS. 6 to 8. Note that the following mainly describes detection operations for detecting an instruction from the user based on detection results from the photosensors 17.

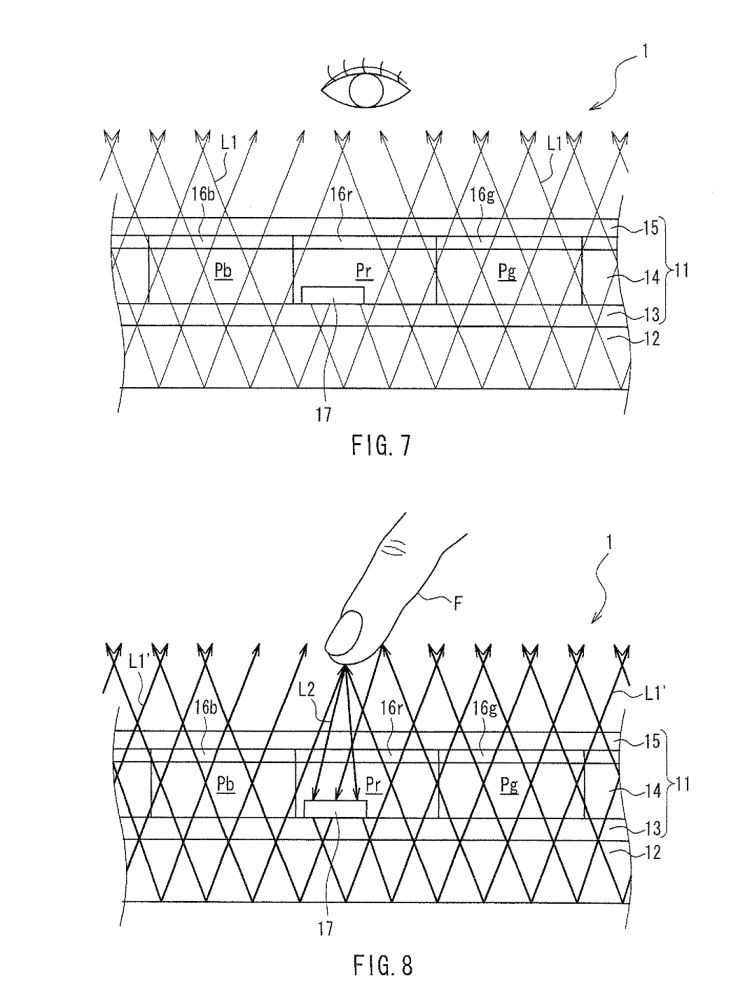

FIG. 6 is a flowchart showing basic detection operations performed by the pointing device. FIG. 7 is a diagram illustrating display operations performed by the liquid crystal display device. FIG. 8 is a diagram illustrating basic detection operations performed by the pointing device.

As shown in step S1 of FIG. 6, the mode determination unit 41a1 in the pointing device drive unit 4 determines whether the standby mode has been released. Upon determining that the standby mode has not been released, the pointing device drive unit 4 determines that the current mode is the standby mode, does not supply power to the photosensors 17, and causes the photosensors 17 to be in the standby state.

Also, as shown in FIG. 7, in the standby mode, the user views a display image on the liquid crystal panel 11 due to the irradiation light L1 from the backlight device 12 reaching the user through the liquid crystal panel 11.

Also, when it has been determined in the step S1 that the standby mode has been released, that is to say, when the mode determination unit 41a1 has determined that the sensing mode has started, the light quantity change instruction unit 43 causes the backlight control unit 32 to increase the brightness of the irradiation light from the backlight device 12 (step S2). Thereafter, the photosensor control unit 41a outputs the instruction signals described above to the sensor column driver 8 and the sensor row driver 9 to cause the photosensors 17 to perform sensing operations (step 53).

Also, since the photosensor sensing processing in step S3 is performed after the brightness increasing processing in step S2, as shown in FIG. 8, the brightness of irradiation light L1′ from the backlight device 12 is higher than the brightness of the irradiation light L1 shown in FIG. 7. Accordingly, the intensity of reflected light L2 that has reflected off the finger F to the liquid crystal panel 11 side is higher than the case of using the irradiation light L1, thus increasing the amount of reflected light L2 that incidences on the photosensors 17. Additionally, compared to the case of using the irradiation light L1, it is possible to increase the difference between the above incidence amount and the incidence amount from photosensors 17 on which the reflected light L2 from the finger F does not incident.

Next, as shown in step S4 of FIG. 6, the pointing device drive unit 4 determines whether it is necessary to increase the brightness. Specifically, the signal processing unit 42 determines whether the photosensor sensing processing in step S3 was performed normally, based on the detection results of the photosensors 17 that are stored in the memory. Upon determining that the photosensor sensing processing was not performed normally, the pointing device drive unit 4 determines that it is necessary to increase the brightness, and processing returns to step S2. Accordingly, the sensing processing is performed by the photosensors 17 again after the brightness of the irradiation light from the backlight device 12 has been increased.

However, in step S4, upon determining that the photosensor sensing processing was performed normally, the pointing device drive unit 4 determines that is not necessary to increase the brightness. Thereafter, as shown in step S5, the mode determination unit 41a1 determines whether the sensing mode has been continued. In the case of a determination that the sensing mode has been continued, processing returns to step S3.

On the other hand, upon determining in step S5 that the sensing mode has not been continued, the pointing device drive unit 4 switches the mode to the standby mode (step S6). In other words, the photosensors 17 are caused to be in the standby state by stopping the supply of power to the photosensors 17.

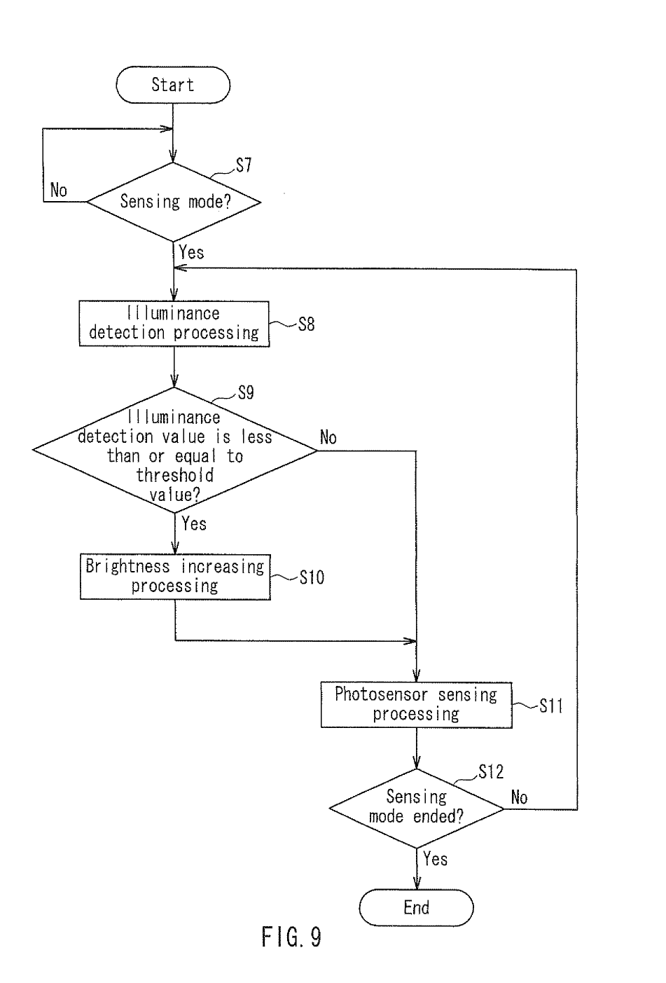

The following describes detection operations performed by the pointing device with use of the detection result from the illuminance sensor S, with reference to FIG. 9 as well.

FIG. 9 is a flowchart showing detection operations performed by the pointing device in the case in which the surrounding environment has changed.

As shown in step S7 of FIG. 9, the mode determination unit 41a1 in the pointing device drive unit 4 determines whether the current mode is the sensing mode. In the case of a determination that the current mode is the sensing mode, the illuminance sensor control unit 41b causes the illuminance sensor S to operate, and acquires a detection value for surrounding illuminance of the liquid crystal panel 11 (step S8).

Next, the surrounding illuminance determination unit 42c determines whether the illuminance detection value detected by the illuminance sensor S is less than or equal to a preset threshold value (step S9). In the case of a determination that the illuminance detection value is less than or equal to the threshold value, similarly to step S2, the light quantity change instruction unit 43 causes the backlight control unit 32 to increase the brightness of the irradiation light from the backlight device 12 (step S10).

Next, as shown in step S11 of FIG. 9, similarly to step S3, sensing operations are executed by the photosensors 17.

On the other hand, in the case of a determination in step S9 that the illuminance detection value exceeds the threshold value, the pointing device drive unit 4 determines that the detection accuracy of the photosensors 17 has not decreased due to the influence of the surrounding illuminance, and the photosensor sensing processing in step S11 is performed without the execution of the brightness increasing processing in step S10.

Next, as shown in step S12 of FIG. 9, the mode determination unit 41a1 of the pointing device chive unit 4 determines whether the sensing mode has ended. In the case of a determination that the sensing mode has not ended, processing returns to step S8.

However, upon determining in step S12 that the sensing mode has ended, the pointing device chive unit 4 switches the mode to the standby mode and causes the photosensors 17 to be in the standby mode.

In the present embodiment having the above configuration, the light quantity change instruction unit (brightness increase instruction unit) 43 instructs the liquid crystal display device 1 to increase the brightness of the light irradiated from the liquid crystal panel 11 toward the outside. Accordingly, as shown in FIG. 8, the intensity of the reflected light from the finger F (detection target) on the photosensor 17 can be improved. As a result, it is possible to improve the detection accuracy of the photosensors 17 unlike in the conventional examples described above. Accordingly, it is possible in the present embodiment to prevent a reduction in the functionality of the pointing device, and detect a user operation (input) instruction with a high degree of accuracy. Also, the pointing device in which a reduction in the detection accuracy of the photosensors 17 and a reduction in functionality arising therefrom are prevented is used in the present embodiment, thereby enabling easily constructing the liquid crystal display device 1 that has high-performance pointing device functionality.

Also, in the present embodiment, the light quantity change instruction unit 43 increases the brightness of the irradiation light by increasing the quantity of the irradiation light from the backlight device 12, thus enabling reliably preventing a reduction in the detection accuracy of the photosensors 17 and a reduction in functionality arising therefrom.

Also, it is possible to prevent the increase in brightness by the backlight device 12 from being seen as flickering in the present embodiment, thus enabling reliably preventing a reduction in the display quality of the liquid crystal display device 1.

Also, in the present embodiment, the light quantity change instruction unit 43 increases the brightness of the irradiation light with use of the determination result of the surrounding illuminance determination unit 42e as shown in FIG. 9, and therefore the light quantity change instruction unit 43 can increase the brightness of the light according to the surrounding illuminance of the liquid crystal panel 11, thus enabling reliably preventing a reduction in the detection accuracy of the photosensors 17 due to the surrounding illuminance.

Also, the position information acquisition unit 42a of the present embodiment acquires position information with use of detection results from the photosensors 17 for which a reduction in detection accuracy has been prevented, thus enabling the position information acquisition unit 42a to easily acquire accurate position information.

Also, the scanner unit 42b of the present embodiment reads image information with use of detection results from the photosensors 17 for which a reduction in detection accuracy has been prevented, thus enabling the scanner unit 42b to easily read accurate image information.

Note that as an alternative to the above description, besides the finger F, a touch pen or the like can be the detection target of the photosensor 17 in the pointing device.

### Embodiment 2

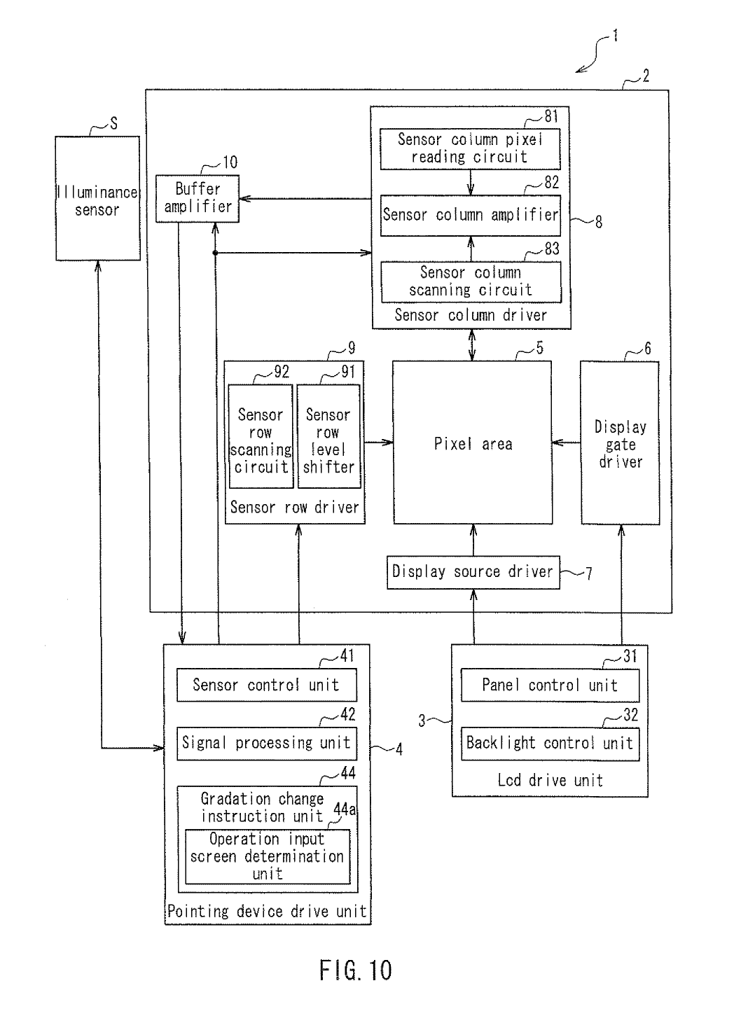

FIG. 10 is a diagram illustrating a schematic configuration of a pointing device and a liquid crystal display device according to Embodiment 2 of the present invention. In FIG. 10, a main difference between the present embodiment and Embodiment 1 is that a gradation change instruction unit that changes a display gradation on the liquid crystal panel is provided instead of the light quantity increase instruction unit. Note that the same reference characters are used for elements that are the same as in Embodiment 1, and redundant descriptions thereof have been omitted.

Specifically, as shown in FIG. 10, the pointing device drive unit 4 of the present embodiment is provided with a gradation change instruction unit 44 that changes a display gradation on the liquid crystal panel 11. The gradation change instruction unit 44 is configured to instruct the panel control unit 31 on the liquid crystal display device 1 side to change the display gradation to a high-brightness gradation. In other words, the gradation change instruction unit 44 instructs that the brightness of the light irradiated from the liquid crystal panel 11 toward the outside be increased by, for each pixel of the liquid crystal panel 11, increasing the transmissivity of the liquid crystal layer 14.

Also, based on the determination result from the surrounding illuminance determination unit 42c, the gradation change instruction unit 44 instructs the panel control unit 31 to increase the brightness of the light. Accordingly, it is possible to reliably prevent a reduction in the detection accuracy of the photosensors 17 due to surrounding illuminance.

Furthermore, similarly to the light quantity change instruction unit 43, the gradation change instruction unit 44 increases the display gradation on the liquid crystal panel 11 at a predetermined cycle, and is configured so as to enable preventing the change in the display gradation on the liquid crystal panel 11 from being seen as flickering, thus preventing a reduction in display quality.

Also, the gradation change instruction unit 44 is provided with an operation input screen determination unit 44a that determines an operation input screen being displayed on the display face of the liquid crystal panel 11, and the gradation change instruction unit 44 increases the brightness of the light by changing the display gradation on the liquid crystal panel 11 in accordance with the operation input screen. Specifically, the operation input screen determination unit 44a receives an input of display data (an image signal) to be displayed on the display face of the liquid crystal, panel 11 from the LCD drive unit 3, and determines display content of the operation input screen based on the input display data. Also, the gradation change instruction unit 44 is configured to increase the brightness of the light for each pixel with use of the determination result (described in detail later).

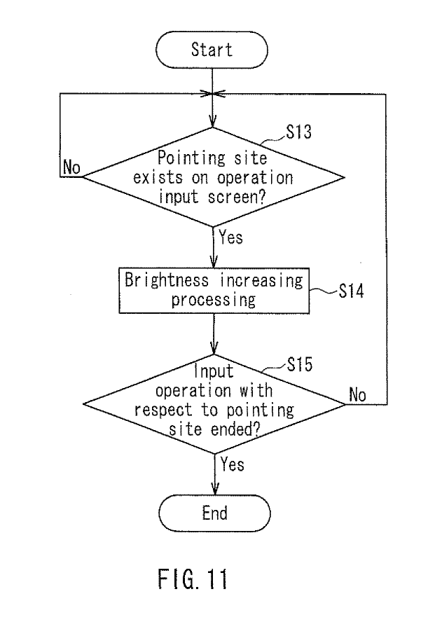

The following is a specific description of operations of the present embodiment with reference to FIGS. 11 to 13 as well. Note the following mainly describes operations performed by the pointing device for adjusting the brightness of the light for each pixel in accordance with the operation input screen.

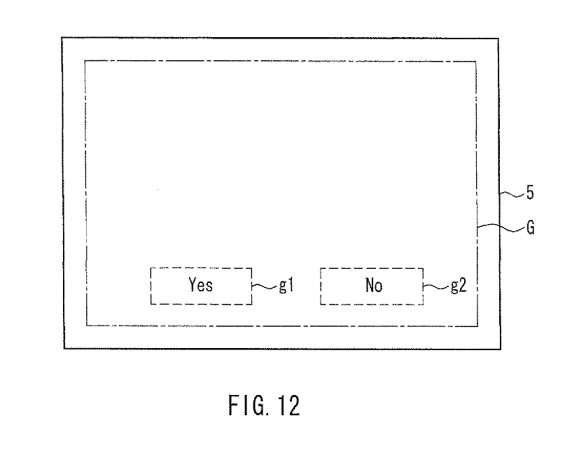

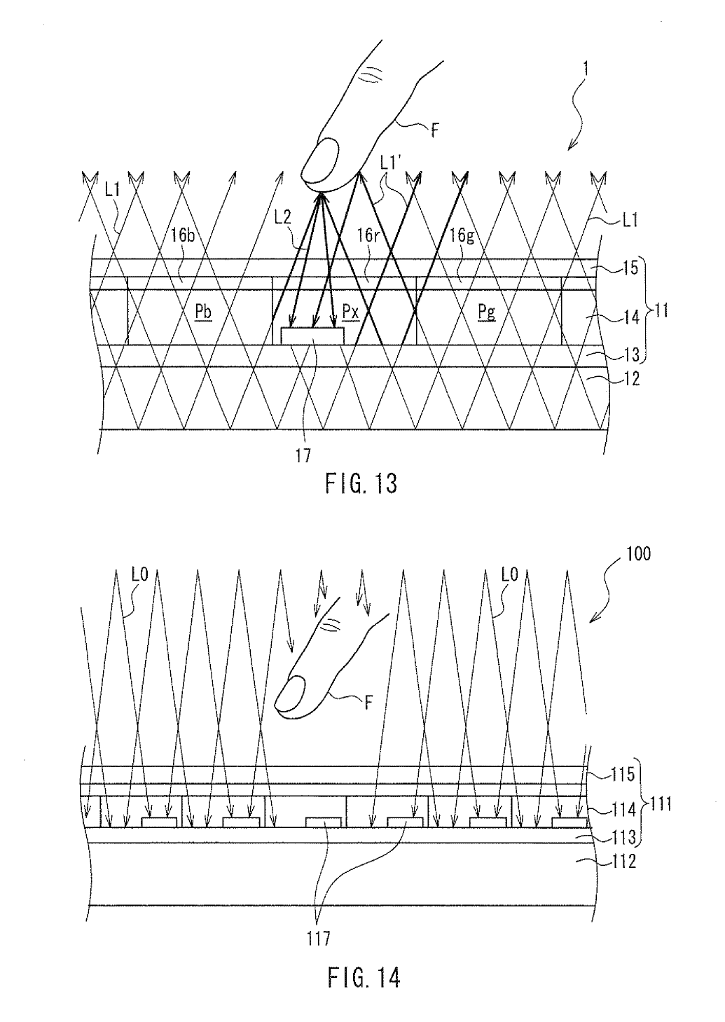

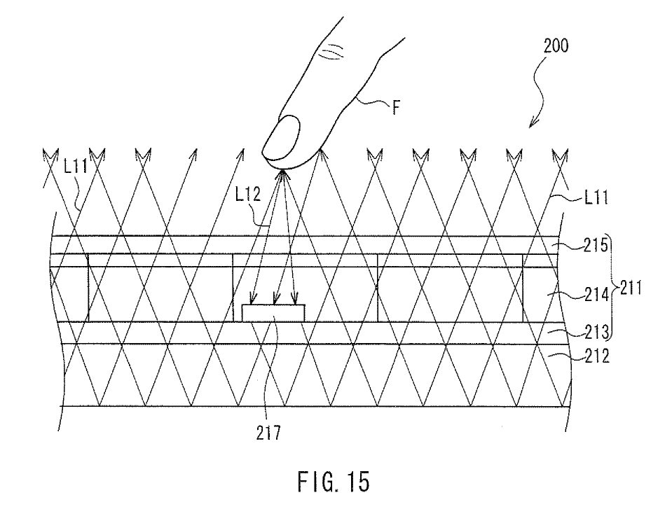

FIG. 11 is a flowchart showing detection operations performed by the pointing device shown in FIG. 10 in accordance with an operation input screen, and FIG. 12 is a diagram illustrating a specific example of an operation input screen displayed on the display face of the liquid crystal display device. FIG. 13 is a diagram illustrating detection operations performed by the pointing device shown in FIG. 10.

As shown in step S13 of FIG. 11, the operation input screen determination unit 44a of the gradation change instruction unit 44 determines whether a pointing site for the input of an operation (instruction) from the user exists on an operation input screen being displayed on the display face. Specifically, the operation input screen determination unit 44a makes a determination regarding whether, for example, pointing sites g1 and g2 have been set in an operation input screen G as shown in FIG. 12. In the case of a determination that the pointing sites g1 and g2 have been set, the gradation change instruction unit 44 increases the brightness of the light for only pixels corresponding to the pointing sites g1 and g2 (step S14).

More specifically, in the liquid crystal display device 1, the transmissivity of a pixel Px corresponding to the pointing sites g1 and g2 is increased at the predetermined cycle as shown in FIG. 13. For this reason, the brightness of the irradiation light L1′ from the backlight device 12 that passes through the pixel Px is higher than the irradiation light L1 from the backlight device 12 that does not pass through the pixel Px. As a result, similarly to Embodiment 1, the intensity of the reflected light L2 that has reflected off the finger F to the liquid crystal panel 11 side is higher than the case of using the irradiation light L1, thus increasing the amount of reflected L2 that incidences on the photosensor 17. Additionally, compared to the case of using the irradiation light L1, it is possible to increase the difference between the above incidence amount and the incidence amount from photosensors 17 on which the reflected light L2 from the finger F does not incident.

Note that in step S14, the gradation change instruction unit 44 may change the gradation of the entire display face to a high-brightness gradation. Also, the gradation change instruction unit 44 may cause a white screen to be displayed on the display face by setting the transmissivity of all pixels of the display face to 100%.

Thereafter, the pointing device drive unit 4 determines whether the input operation with respect to the pointing sites has ended (step S15), and in the case of a determination that the input operation has not ended, processing returns to step S13. On the other hand, upon determining that the input operation has ended, the pointing device drive unit 4 stops the detection operations.

As described above, in the present embodiment, the gradation change instruction unit (brightness increase instruction unit) 44 increases the transmissivity of the liquid crystal layer 14 of the liquid crystal panel, 11, thereby improving the intensity of the reflected light L2. Accordingly, similarly to Embodiment 1, the present embodiment enables reliably preventing a reduction in the detection accuracy of the photosensors 17 and a reduction in functionality arising therefrom.

Also, in the present embodiment, the gradation change instruction unit 44 can increase the brightness of the light in accordance with the operation input screen, thereby enabling reliably preventing a reduction in the detection accuracy of the photosensors 17 due to the brightness of the operation input screen.

Also, in the present embodiment, as shown in FIGS. 12 and 13, the gradation change instruction unit 44 increases the brightness of the light for only the pixel Px corresponding to the pointing sites g1 and g2, thereby enabling more appropriately causing the liquid crystal display device 1 to increase the brightness of the light, without instructing unnecessary increases in brightness.

Note that the embodiments described above are all exemplary and not limiting. The technical scope of the present invention is defined by the claims, and the technical scope of the present invention also encompasses all changes that fall in a range equivalent to the configurations described in the claims.

For example, although the case of applying the present invention to the transmissive liquid crystal display device is described above, the present invention is not limited to this, and it is possible to apply the present invention to a semi-transmissive liquid crystal display device, various types of non-light-emitting display devices such as a projection display device, an example of which is a rear projection display using the liquid crystal panel as a light bulb, or various types of light-emitting display devices such as a CRT (Cathode Ray Tube), a plasma display, or an organic EL (Electronic Luminescence) display.

Specifically, in a non-light-emitting display device equipped with a light source (a backlight device), the light quantity change instruction unit of Embodiment 1, the gradation change instruction unit of Embodiment 2, or a combination of these can be used as the brightness increase instruction unit that instructs the display device to increase the brightness of the light irradiated from the display unit toward the outside. The case of using a combination of the light quantity change instruction unit and the gradation change instruction unit is preferable in that brightness adjustment (brightness increasing) can be easily performed for each pixel, and furthermore the range of brightness adjustment can be easily increased.

On the other hand, with a light-emitting display device that does not include a light source, it is possible to use the gradation change instruction unit as the brightness increase instruction unit. Specifically, by increasing the emission intensity of the luminescent material in the organic EL display, or increasing the emission intensity of a discharge cell in the plasma display, it is possible to increase the brightness of the light that is irradiated from the corresponding display unit toward the outside.

Also, although a configuration in which photosensors are provided integrally on the active matrix substrate and the photosensors are incorporated inside the liquid crystal panel as the display unit is described above, the photosensors of the present invention are not limited in any way as long as they are provided for each pixel on the display unit side of the display device. Specifically, in the case of applying the present invention to a display device such as the CRT in which photosensors cannot be easily incorporated in the display unit, a configuration is also possible in which a photosensor is provided for each pixel on a transparent substrate, and the transparent subject can be attached to and removed from the display unit of the display device, thus enabling disposing the transparent substrate on the display unit as necessary.

Note that the case of integrally providing the photosensors on the active matrix substrate and incorporating the photosensors in the liquid crystal panel as described above is preferable in that a small size and thinness can be achieved, and furthermore it is possible to construct a display device that has a small number of parts and incorporates a pointing device that is inexpensive and has high performance.

### INDUSTRIAL APPLICABILITY

The present invention can prevent a reduction in the detection accuracy of a photosensor and can prevent a reduction in functionality, and therefore is useful to a pointing device that has high performance, is inexpensive, and can detect an instruction or the like from a user with high accuracy, and a display device using the same.

1. A pointing device used in a display device that includes a display unit equipped with a plurality of pixels and that is configured such that an operation input screen can be displayed on the display unit, the pointing device comprising:
a photosensor provided for each pixel; and
a brightness increase instruction unit that instructs the display device to increase the brightness of light irradiated from the display unit toward the outside.

2. The pointing device according to claim 1,
wherein the brightness increase instruction unit instructs the display device to, at a predetermined cycle, increase the brightness of the light irradiated from the display unit toward the outside.

3. The pointing device according to claim 1,
wherein a light quantity change instruction unit that changes the quantity of irradiated light from a backlight device provided on the display device side is used in the brightness increase instruction unit.

4. The pointing device according to claim 1,
wherein a gradation change instruction unit that changes a display gradation on the display unit is used in the brightness increase instruction unit.

5. The pointing device according to claim 1,
wherein the pointing device comprises an illuminance sensor that is provided in the proximity of the display unit and detects a surrounding illuminance of the display unit, and
the brightness increase instruction unit instructs the display device to increase the brightness of the light irradiated from the display unit toward the outside, with use of a determination result of the illuminance sensor.

6. The pointing device according to claim 1,
wherein the brightness increase instruction unit instructs the display device to increase the brightness of the light irradiated from the display unit toward the outside, in accordance with an operation input screen displayed on the display unit.

7. The pointing device according to claim 1,
wherein the brightness increase instruction unit instructs the display device to, for each pixel, increase the brightness of the light irradiated from the display unit toward the outside.

8. The pointing device according to claim 1,
wherein the pointing device comprises a position information acquisition unit that, with use of a detection result of each photosensor, acquires position information with respect to the operation input screen displayed on the display unit.

9. The pointing device according to claim 1,
wherein the pointing device comprises a scanner unit that reads image information with use of the detection result of each photosensor.

10. A display device that uses the pointing device according to claim 1.

11. The display device according to claim 10,
wherein a liquid crystal panel is used in the display unit, and
each photosensor is provided integrally with an active matrix substrate of the liquid crystal panel.
